(19) United States
(12) Patent Application Publication
(10) Pub. No.: US 2026/0042211 A1
(43) Pub. Date: Feb. 12, 2026

(54) CONTROL METHOD AND SYSTEM FOR ROBOT

(71) Applicant: M2MTech Co., Ltd., Seongnam-si (KR)

(72) Inventors: Jinkee KIM, Seongnam-si (KR); Jaehyoung KIM, Seongnam-si (KR)

(21) Appl. No.: 18/979,899

(22) Filed: Dec. 13, 2024

(30) Foreign Application Priority Data
Dec. 15, 2023 (KR) 10-2023-0182702

(51) Int. Cl. B25J 9/16; B25J 11/00; B66B 1/34

(52) U.S. Cl. CPC B25J 9/1679; B25J 9/161; B25J 9/1661; B25J 11/008; B66B 1/3461

(57) ABSTRACT

A robot control method for controlling at least one robot providing a robot service in a building where a plurality of elevators installed in a robot control apparatus may be provided. The robot control method may include receiving an elevator boarding request from a first robot among the at least one robot; receiving operation status information of each of the plurality of elevators from each of a plurality of control panels; predicting an elevator to be allocated by a group management controller when an elevator is called according to an elevator boarding request, based on the operation status information of each of the plurality of elevators and elevator allocation history information of the group management controller; and transmitting allocation prediction information including information of the predicted elevator to the first robot.

### APPLICATION

This application claims priority to and the benefit of Korean Patent Application No. 10-2023-0182702 filed in the Korean Intellectual Property Office on Dec. 15, 2023, the entire contents of which are incorporated herein by reference.

### BACKGROUND OF THE INVENTION

### 1. Field of the Invention

This disclosure relates to a robot control method and apparatus.

### 2. Description of the Related Art

Recently, with the advancement of mobile robot technology, the service area using mobile robots is expanding.

As an example, robots could be used for tasks that follow set routes within a building, such as delivery services, cleaning services, and guiding services. In this case, the robots must use an elevator to move from floor to floor in the building, and there is a need for interoperability between the robots and the elevator system already installed in the building.

Typically, when a plurality of elevators installed in a building, the elevator system may include a plurality of control panels that control the plurality of elevators, and a group management controller that is connected to the plurality of control panels and allocates elevators in response to elevator calls.

In order to provide a service using robots, the robot control apparatus controlling the robots should transmit the elevator allocation results to the robots, and the robot control apparatus should be linked to the group management controller or to the plurality of control panels to receive the elevator allocation results from the group management controller. In the case of some conventional control panels, linkage with the robot control apparatus is possible, but the control panels only transmit limited elevator information to the robot control apparatus and do not transmit the elevator allocation results of the group management controller. In addition, in the case of the group management controller, there is no separate communication interface for external linkage. Therefore, in order to communicate with the robot control apparatus, the existing group management controller should be modified, or the already installed group management controller should be replaced with a modified group management controller, and this may impose a cost burden.

### SUMMARY OF THE INVENTION

Some embodiments may provide a robot control method and apparatus capable of providing robot services within a building without modifying a manufactured group management controller or replacing an installed group management controller.

In a general aspect, a robot control method for controlling at least one robot providing a robot service in a building where a plurality of elevators installed in a robot control apparatus operated by a processor includes: receiving an elevator boarding request from a first robot among the at least one robot; receiving operation status information of each of the plurality of elevators from each of a plurality of control panels; predicting an elevator to be allocated by a group management controller when an elevator is called according to an elevator boarding request, based on the operation status information of each of the plurality of elevators and elevator allocation history information of the group management controller; and transmitting allocation prediction information including information of the predicted elevator to the first robot.

The robot control method may further include, transmitting an elevator call according to the elevator boarding request to the group management controller through at least one of the plurality of control panels, after the transmitting the allocation prediction information to the first robot.

The receiving operation status information of each of the plurality of elevators may include, periodically and non-periodically receiving operation status information of each of the plurality of elevators from each of the plurality of control panels, and the predicting is performed each time the operation status information of each of the plurality of elevators is received until the elevator allocated by the group management controller arrives according to the elevator call.

The robot control method may further include, checking arrival information of the elevator allocated by the group management controller according to the elevator call, and transmitting the arrival information to the first robot.

The robot control method may further include, determining whether the first robot is able to board the predicted elevator, before transmitting the allocation prediction information to the first robot.

The robot control method may further include, transmitting the elevator call according to the elevator boarding request to the group management controller through at least one of the plurality of control panels, after transmitting the allocation prediction information to the first robot; and delaying, until it is determined that the first robot can board the predicted elevator, a transmission of the elevator call when it is determined that the first robot cannot board the predicted elevator.

The robot control method may further include, transmitting a call signal including information of another elevator to the group management controller through at least one of the plurality of control panels when it is determined that the first robot cannot board the predicted elevator.

The determining whether the first robot is able to board the predicted elevator may include, determining whether the first robot is able to board the predicted elevator by considering the number of robots that can board the elevator and a loading capacity of the elevator.

The receiving operation status information of each of the plurality of elevators may include, periodically and non-periodically receiving operation status information of each of the plurality of elevators from each of the plurality of control panels; storing operation status information of each of the plurality of elevators; identifying an elevator allocation result of the group management controller by analyzing the operation status information of each of the plurality of elevators; and managing the elevator allocation history information by storing the identified elevator allocation result.

The predicting an elevator to be allocated may include, estimating elevator allocation rules used by the group management controller for elevator allocation based on the elevator allocation history information of the group management controller stored during a predetermined period of time; and predicting the elevator to be allocated by the group management controller using the operation status information of each of the plurality of elevators and the elevator allocation rules.

In another general aspect, a robot control apparatus that controls at least one robot providing robot service in a building where a plurality of elevators are installed includes a processor and a memory, wherein the memory stores instructions configured to cause the processor to perform a process, and the process includes: receiving an elevator boarding request from a first robot among at least one of the robots; receiving operation status information of the plurality of elevators from the plurality of control panels that respectively control the plurality of elevators; predicting an elevator to be allocated by a group management controller using elevator allocation rules and operation status information of the plurality of elevators, before transmitting an elevator call according to the elevator boarding request to the group management controller; and transmitting allocation prediction information for the elevator to be allocated by the group management controller to the first robot.

The process may further include, estimating the elevator allocation rules of the group management controller based on elevator allocation history information of the group management controller according to operation status information of the plurality of elevators received during a predetermined period of time, before receiving the elevator boarding request.

The process may further include, transmitting an elevator call according to the elevator boarding request to the plurality of control panels, after transmitting allocation prediction information to the first robot.

The predicting an elevator to be allocated by a group management controller may include, predicting an elevator to be allocated by the group management controller by using the elevator allocation rules and the operation status information of the plurality of elevators, each time the operation status information of each of the plurality of elevators is received, until the elevator allocated d by the group management controller arrives according to the elevator call.

The transmitting to the first robot may include, determining whether the first robot is able to board the predicted elevator; and transmitting the allocation prediction information to the first robot when the first robot can board the predicted elevator.

The process may further include, generating a call signal including information about another elevator when it is determined that the first robot cannot board the predicted elevator.

The process may further include, delaying, until it is determined that the first robot can board the predicted elevator, a transmission of the elevator call when it is determined that the first robot cannot board the predicted elevator.

The process may further include updating the elevator allocation rules at a predetermined cycle while the plurality of elevators are in operation.

### BRIEF DESCRIPTION OF THE DRAWINGS

FIG. 1 illustrates an elevator system to which at least one robot according to one or more embodiments is applied.

FIG. 2 illustrates a method for managing elevator allocation history information of a group management controller 200 in a robot control apparatus.

FIG. 3 illustrates an elevator allocation method when a robot calls an elevator according to one or more embodiments.

FIG. 4 illustrates an elevator allocation method when a robot calls an elevator according to one or more embodiments.

FIG. 5 illustrates a robot control apparatus according to one or more embodiments.

FIG. 6 illustrates a robot control apparatus according to one or more embodiments.

### DETAILED DESCRIPTION OF THE EMBODIMENTS

Hereinafter, embodiments of the disclosure will be described in detail with reference to the attached drawings so that a person of ordinary skill in the art may easily implement the disclosure. As those skilled in the art would realize, the described embodiments may be modified in various different ways, all without departing from the spirit or scope of the disclosure. The drawings and description are to be regarded as illustrative in nature and not restrictive. Like reference numerals designate like elements throughout the specification.

Furthermore, when a component is referred to be “connected” with another component, it includes not only the case where two components are “directly connected” but also the case where two components are “indirectly or non-contactedly connected” with another component interposed therebetween, or the case where two components are “electrically connected.”

In addition, when a part is referred to “include” a certain element, it means that it may further include other elements rather than exclude other elements, unless specifically indicated otherwise.

Furthermore, in the flowchart described with reference to the drawings in this specification, the order of operations may be changed, several operations may be merged, some operations may be divided, and specific operations may not be performed.

Now, a robot control method and apparatus according to one or more embodiments will be described in detail with reference to the drawings.

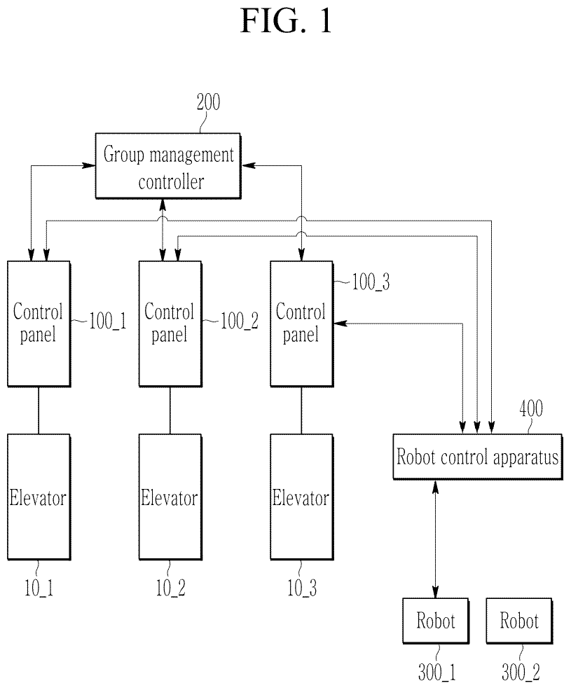

FIG. 1 illustrates an elevator system to which at least one robot according to one or more embodiments is applied.

Referring to FIG. 1, a plurality of elevators 10_1, 10_2, and 10_3 are installed in the building. For convenience, FIG. 1 shows three elevators 10_1, 10_2, and 10_3 installed.

An elevator system installed in a building may include a plurality of control panels 100_1, 100_2, and 100_3, a group management controller 200, and a robot control apparatus 400.

The plurality of control panels 100_1, 100_2, and 100_3 may be installed to correspond to a plurality of elevators 10_1, 10_2, and 10_3, respectively, and may monitor the operation of the corresponding elevators 10_1, 10_2, and 10_3.

The plurality of control panels 100_1, 100_2, and 100_3 are devices in which all control circuits for the operation of the elevators 10_1, 10_2, and 10_3 are concentrated, and may perform functions such as controlling the operating speed of the elevators 10_1, 10_2, and 10_3, receiving signals from various safety devices to determine whether any safety abnormalities exist, and supplying power necessary for operation and lighting.

When the plurality of control panels 100_1, 100_2, and 100_3 receive an elevator call signal from a user, they may transmit an elevator allocation request to the group management controller 200, and control the elevators 10_1, 10_2, and 10_3 according to the elevator allocation response corresponding to the elevator allocation request from the group management controller 200. According to one or more embodiments, the user may include a person, a robot control apparatus 400, and robots 300_1 and 300_2.

Each of the plurality of control panels 100_1, 100_2, and 100_3 may collect operation status information of corresponding elevators 10_1, 10_2, and 10_3 periodically and/or when an event occurs, and transmit the collected operation status information of corresponding elevators 10_1, 10_2, and 10_3 to the group management controller 200.

In addition, the plurality of control panels 100_1, 100_2, and 100_3 may transmit at least some of the collected operation status information of the elevators 10_1, 10_2, and 10_3 to the robot control apparatus 400.

The information exchanged between the plurality of control panels 100_1, 100_2, and 100_3 and the robot control apparatus 400 may be limited.

In some embodiments, the operation status information transmitted by the plurality of control panels 100_1, 100_2, and 100_3 to the robot control apparatus 400 may include the current floor of the elevators 10_1, 10_2, and 10_3, operation direction information, door status information, car call information including a destination floor input by the user, hall call information which calls the elevator to the floor where the user is located, car call release information, and hall call release information. The hall call may correspond to a group call for elevators, and a car call may correspond to an individual elevator call. An elevator call signal described in the specification may mean the hall call signal unless otherwise specified.

In some embodiments, the operation status information by the plurality of control panels 100_1, 100_2, and 100_3 to the robot control apparatus 400 may further include additional information such as target floor information, fault status information, inspection status information, operation speed information, load information, brake status information, and encoder pulses, and the additional information may be transmitted to the robot control apparatus 400.

When the group management controller 200 receives the elevator call signal from at least one of the plurality of control panels 100_1, 100_2, and 100_3, it may allocate an optimal elevator among the plurality of elevators 10_1, 10_2, and 10_3 to the floor called by the user by using the operation status information of the plurality of elevators 10_1, 10_2, and 10_3 and the set elevator allocation rules.

In some embodiments, the group management controller 200 may estimate the power consumption of each elevator 10_1, 10_2, and 10_3 according to the location of each elevator 10_1, 10_2, and 10_3 and the user occupancy rate of each elevator 10_1, 10_2, and 10_3, and allocate the optimal elevator to the floor called by the user while considering operation efficiency and energy saving.

At least one robot 300_1 and 300_2 may be an autonomous mobile robot that may board an allocated elevator and move between floors through the allocated elevator, and may operate under the control of a robot control apparatus 400. For convenience, only two robots 300_1 and 300_2 are shown in FIG. 1.

The robots 300_1 and 300_2 may provide robot services by moving through each floor of the building. In some embodiments, the robot service may be a delivery service.

The robot 300_1 and 300_2 may transmit an elevator boarding request signal to the robot control apparatus 400 to call an elevator for moving between floors.

The robot 300_1 and 300_2 may receive allocation prediction information about the elevator to be boarded from the robot control apparatus 400, and may move to the location of the elevator to be allocated in advance and wait according to the allocation prediction information.

The robot control apparatus 400 may control and manage at least one robot 300_1 and 300_2. The robot control apparatus 400 may communicate with at least one robot 300_1 and 300_2 through wireless communication.

The robot control apparatus 400 may communicate with the plurality of control panels 100_1, 100_2, and 100_3. The robot control apparatus 400 may communicate with the plurality of control panels 100_1, 100_2, and 100_3 through wired or wireless communication.

The robot control apparatus 400 may receive operation status information of the elevators 10_1, 10_2, and 10_3 from the plurality of control panels 100_1, 100_2, and 100_3.

When the robot control apparatus 400 receives an elevator boarding request signal from the robot 300_1 among the robots 300_1 and 300_2, it may transmit an elevator call signal to at least one control panel among the plurality of control panels 100_1, 100_2, and 100_3. In some embodiments, to reduce the overall communication load of the elevator system, the elevator call signal may be transmitted to one of the plurality of control panels 100_1, 100_2, and 100_3.

When the robot control apparatus 400 according to one or more embodiments receives the elevator boarding request signal from the robot 300_1, before transmitting the elevator call signal to at least one control panel among the plurality of control panels 100_1, 100_2, and 100_3, it may predict elevator allocation information of the group management controller 200, which is information on an elevator to be allocated by the group management controller 200 in response to the elevator boarding request. The robot control apparatus 400 may transmit elevator allocation prediction information to the robot 300_1 that sent the elevator boarding request. The elevator allocation prediction information may include information about the predicted elevator. After the robot control apparatus 400 transmits elevator allocation prediction information to the robot 300_1, it may transmit an elevator call signal to at least one of the plurality of control panels 100_1, 100_2, and 100_3.

The group management controller 200 may allocate an optimal elevator based on the elevator allocation rules and the operation status information of the elevators 10_1, 10_2, and 10_3 in response to the elevator allocation requests from the plurality of control panels 100_1, 100_2, and 100_3. At this time, the robot control apparatus 400 cannot know which elevator is allocated by the group management controller 200. That is, the plurality of control panels 100_1, 100_2, and 100_3 receive elevator allocation information of the group management controller 200 from the group management controller 200, but do not transmit the elevator allocation information to the robot control apparatus 400, so the robot control apparatus 400 cannot know the elevator allocation information of the group management controller 200 corresponding to the elevator call signal.

The robot control apparatus 400 according to one or more embodiments may predict an elevator to be allocated by the group management controller 200 in response to the elevator call signal based on operation status information of elevators 10_1, 10_2, and 10_3 received from the plurality of control panels 100_1, 100_2, and 100_3 and elevator allocation history information of the group management controller 200 collected over a predetermined period of time.

In this way, the robot control apparatus 400 may not require separate communication with the group management controller 200 when providing robot services by predicting the elevator allocation information of the group management controller 200, and there is no need to modify or replace the group management controller 200 for communication with the robot control apparatus 400.

The robot control apparatus 400 may predict elevator allocation information of the group management controller 200, transmit the elevator allocation prediction information to the robot 300_1 that transmitted the elevator boarding request signal, and then transmit the elevator call signal to at least one of the plurality of control panels 100_1, 100_2, and 100_3. Then, the control panel that receives the elevator call signal may request elevator allocation to the group management controller 200, and the group management controller 200 may allocate the optimal elevator in response to the elevator allocation request.

In this way, prediction of elevator allocation information of the robot control apparatus 400 may be performed before the elevator allocation request is transmitted to the group management controller 200.

In some embodiments, the robot control apparatus 400 may identify information on elevators actually allocated by the group management controller 200 using the operation status information of the elevators 10_1, 10_2, and 10_3, and store the elevator allocation information of the group management controller 200. Furthermore, the robot control apparatus 400 may manage the elevator allocation information of the group management controller 200. The robot control apparatus 400 may estimate the elevator allocation rules of the group management controller 200 by using the elevator allocation history information of the group management controller 200 stored for a predetermined period of time.

The robot 300_1 that has transmitted the elevator boarding request signal may receive elevator allocation prediction information from the robot control apparatus 400, and may move to the location of the elevator to be boarded in advance based on the elevator allocation prediction information and wait.

Meanwhile, before transmitting elevator allocation prediction information to the robot 300_1, the robot control apparatus 400 may determine whether the robot 300_1 is able to board the predicted elevator. The robot control apparatus 400 may determine whether the robot 300_1 is able to board the elevator based on predetermined elevator boarding restriction conditions.

When the robot control apparatus 400 determines that the robot 300_1 can board the predicted elevator, the robot control apparatus 400 may transmit elevator allocation prediction information to the robot 300_1.

When the robot control apparatus 400 determines that the robot 300_1 cannot board the predicted elevator, the robot control apparatus 400 may delay the transmission time of the elevator call signal to be transmitted to the plurality of control panels 100_1, 100_2, and 100_3 or transmit a signal for calling an elevator other than the predicted elevator to the plurality of control panels 100_1, 100_2, and 100_3.

When the group management controller 200 actually allocates an elevator in response to the elevator call signal, a control panel controlling the allocated elevator among the plurality of control panels 100_1, 100_2, and 100_3 may receive elevator allocation information and control the operation of the allocated elevator based on the elevator allocation information. The allocated elevator may stop at a target floor where the robot 300_1 requested boarding.

The robot control apparatus 400 may check the arrival information of the allocated elevator based on the operation status information received from the plurality of control panels 100_1, 100_2, and 100_3 and transmit the arrival information of the elevator to the robot 300_1 that has transmitted the elevator boarding request signal.

The robot 300_1 that has transmitted the elevator boarding request signal ay move to the location of the elevator to be boarded in advance based on elevator allocation prediction information and wait, and then board the elevator immediately when it receives arrival information of the elevator.

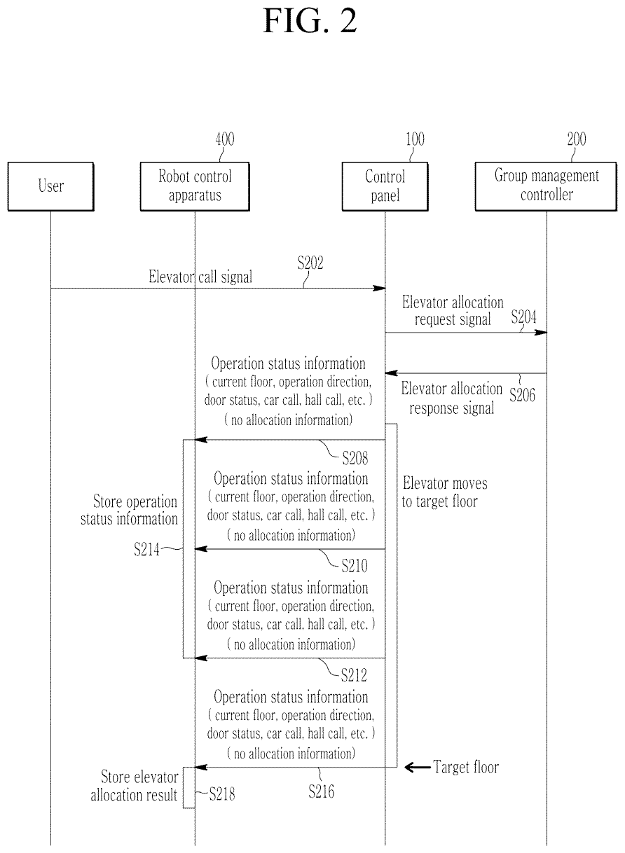

FIG. 2 illustrates a method for managing elevator allocation history information of a group management controller 200 in a robot control apparatus. For convenience, one control panel 100 is illustrated in FIG. 2, but control panels installed within the building may operate identically or similarly to the control panel 100 illustrated in FIG. 2.

Referring to FIG. 2, the control panel 100 may receive an elevator call signal from a user (S202). The elevator call signal may include information about the target floor.

The control panel 100 may transmit an elevator allocation request signal corresponding to the elevator call signal to the group management controller 200 (S204). The elevator allocation request signal may include information included in the elevator call signal. The elevator allocation request signal may be the same signal as the elevator call signal depending on the communication standards between the control panel 100 and the group management controller 200.

The group management controller 200 may allocate one elevator from among the plurality of elevators based on the elevator allocation rules and the operation status information of each elevator, and transmit an elevator allocation response signal including information on the allocated elevator to the control panel 100 (S206). The group management controller 200 may transmit the elevator allocation response signal to the control panel 100 that controls the allocated elevator.

The control panel 100 controlling the allocated elevator may control the allocated elevator based on the elevator allocation response signal.

While the allocated elevator is operating to the target floor, the control panel 100 may periodically and/or when an event occurs transmit operation status information of the elevator to the robot control apparatus 400 (S208, S210, and S212). The event may include, for example, an elevator stopping, a hall call being received, a car call being received, etc.

In addition to the control panel 100 that controls the allocated elevator among the plurality of control panels, the remaining control panels may also transmit the elevator operation status information to the robot control apparatus 400 periodically and/or when an event occurs.

The robot control apparatus 400 may store the operation status information of the elevator received from the control panel 100 (S214), and manage the operation history information of elevators.

Meanwhile, when the elevator reaches the target floor, the door open and close and the elevator call signal may be released.

When the elevator arrives at the target floor, the control panel 100 may transmit the operation status information of the elevator to the robot control apparatus 400 (S216). The control panel 100 may store operation status information of the elevator.

Based on the collected operation status information of the elevator, the robot control apparatus 400 may check the elevator allocation result of the group management controller 200. The elevator allocation result may include a time point of the elevator call, location information of the elevator call (e.g., the floor where the elevator was called), and information about the actual allocated elevator. Specifically, the robot control apparatus 400 may identify the time point of the elevator call and the information on the elevator allocated by the group management controller 200 based on current floor information, door status information, car call information, hall call information, etc. received from the control panel 100. As an example, at some time point, the door status is open and the car call for that floor is released, it may be known that the current floor is the destination floor of the user who is on board, and this time point may be known as the arrival time point of the elevator. In addition, at some time point, the door status is open and the hall call for that floor is released, it may be known that the current floor is a target floor the user wants to board, and that this time point is the arrival point of the elevator.

The robot control apparatus 400 may by store the elevator call time and the elevator allocation result of the group management controller 200 (S218), and manage the elevator allocation history information of the group management controller 200.

The robot control apparatus 400 may estimate the elevator allocation rules of the group management controller 200 based on the elevator call times and elevator allocation results of the group management controller 200 stored for a predetermined period of time and the operation status information of each elevator stored for the predetermined period of time.

The robot control apparatus 400 may store and manage the operation history information of the elevators and the elevator allocation history information of the group management controller 200 while the elevators are in operation, and may periodically update the elevator allocation rules of the group management controller 200 based on the elevator allocation history information of the group management controller 200.

The robot control apparatus 400 may predict elevator allocation result of the group management controller 200, which is information on an elevator to be allocated by the group management controller 200, based on the elevator allocation rules of the group management controller 200 and the operation status information of each elevator when an elevator call is made from the robot (e.g., 300_1 of FIG. 1).

When the robot control apparatus 400 may communicate with the group management controller 200, there is no need to predict the elevator allocation result of the group management controller 200. The group management controller 200 of the elevator system generally installed in a building may be manufactured by various manufacturers and the models may also vary. Therefore, in order to enable communication between the group management controller 200 and the robot control apparatus 400, consultation is required with each manufacturer or model of the group management controller 200, and a group management controller that has already been manufactured needs to be modified or replaced. Therefore, it is difficult to modify or replace the group management controller 200 for communicating with a robot control apparatus 400, and to apply the modified or replaced group management controller 200 in an actual field. In addition, it may be difficult to apply robot services to a building where an older model of the group management controller for which it is difficult to negotiate with the manufacturer is installed.

The robot control apparatus 400 according to one or more embodiments may estimate the elevator allocation rules of the group management controller 200 by using the operation status information of the elevators collected through communication with the control panels 100_1 100_2, and 100_3, and predict the elevator to be allocated by the group management controller 200 by using the estimated elevator allocation rules of the group management controller 200. Accordingly, the robot control apparatus 400 may not require separate communication with the group management controller 200.

In addition, the group management controller 200 uses different elevator allocation rules for each manufacturer or model, and the robot control apparatus 400 may perform an elevator allocation prediction operation regardless of the manufacturer or model of the group management controller 200 by estimating the elevator allocation rules of the group management controller 200 based on the elevator allocation history information.

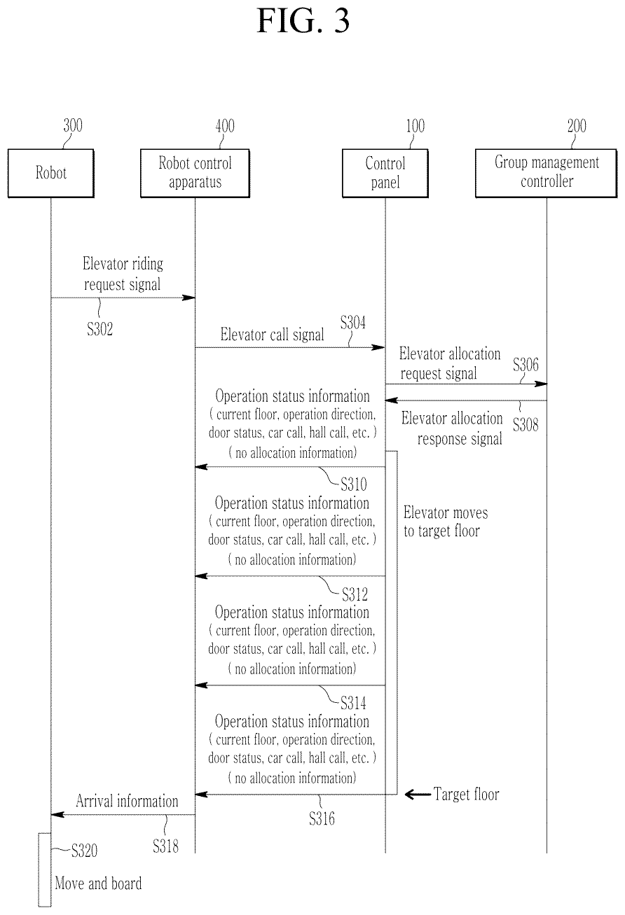

FIG. 3 illustrates an elevator allocation method when a robot calls an elevator according to one or more embodiments.

Referring to FIG. 3, when the robot control apparatus 400 receives an elevator boarding request signal from the robot 300 (S302), the robot control apparatus 400 may transmit an elevator call signal to the control panel 100 (S304).

The control panel 100 may transmit an elevator allocation request signal corresponding to the elevator call signal to the group management controller 200 (S306).

The group management controller 200 may allocate one elevator from among the plurality of elevators based on the elevator allocation rules and the operation status information of each elevator, and transmit an elevator allocation response signal including information on the allocated elevator to the control panel 100 (S308).

The control panel 100 may control the allocated elevator based on the elevator allocation response signal.

While the allocated elevator is operating to the target floor, the control panel 100 may periodically and/or when an event occurs transmit operation status information of the elevator to the robot control apparatus 400 (S310, S312, and S314).

When the elevator arrives at the target floor, the control panel 100 may transmit the operation status information of the elevator to the robot control apparatus 400 (S318).

The robot control apparatus 400 may check the arrival information of the elevator allocated by the group management controller 200 based on the elevator operation status information received from the control panel 100 when the elevator arrives at the target floor.

The robot control apparatus 400 may transmit the arrival information of the elevator to the robot 300 (S320).

The robot 300 may move to the elevator to be boarded according to the arrival information of the elevator and board the elevator (S322).

In this way, according to the existing elevator allocation method, after the elevator allocated by the group management controller 200 arrives at the target floor, the robot 300 may move to the location of the allocated elevator and board the elevator. Accordingly, since the elevator has already arrived when the robot 300 starts moving, it may take a relatively long time for the robot 300 to board, which may be inefficient in terms of time.

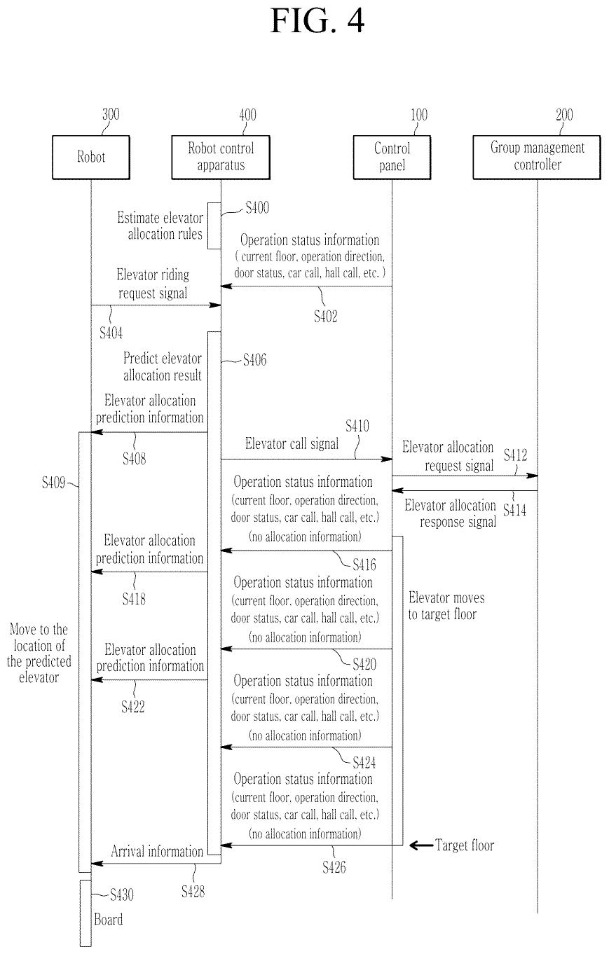

According to one or more embodiments, when the robot control apparatus 400 receives the elevator boarding request signal from the robot 300, the robot control apparatus 400 may predict the elevator allocation result of the group management controller 200 and transmit the allocation prediction information to the robot 300, before transmitting an elevator call signal to the control panel 100. These embodiments are described in detail with reference to FIG. 4.

FIG. 4 illustrates an elevator allocation method when a robot calls an elevator according to one or more embodiments.

Referring to FIG. 4, the robot control apparatus 400 may estimate the elevator allocation rules of the group management controller 200 through the processes of FIG. 2 (S400).

The robot control apparatus 400 may periodically receive elevator operation status information from the control panel 100 (S402).

Thereafter, when the robot control apparatus 400 receives an elevator boarding request signal from the robot 300 (S404), the robot control apparatus 400 may predict the elevator allocation information of the group management controller 200 when the elevator is called based on the estimated elevator allocation rules and the elevator operation status information received from the control panel 100 (S406). That is, when the robot control apparatus 400 receives an elevator boarding request signal from the robot 300 (S404), the robot control apparatus 400 may predict the elevator allocation information of the group management controller 200 (S406), before transmitting the elevator call signal to the control panel 100.

The robot control apparatus 400 may transmit elevator allocation prediction information to the robot 300 (S408).

Next, the robot control apparatus 400 may transmit an elevator call signal to the control panel 100 (S410).

Meanwhile, when the robot 300 that has transmitted the elevator boarding request signal receives elevator allocation prediction information from the robot control apparatus 400 (S408), the robot 300 may move in advance to the location of the elevator to be boarded based on the elevator allocation prediction information and wait (S409).

In some embodiments, the robot control apparatus 400 may determine whether the robot 300 is able to board the elevator before transmitting the elevator allocation prediction information to the robot 300.

When the robot control apparatus 400 determines that the robot 300 can board the predicted elevator, the robot control apparatus 400 may transmit elevator allocation prediction information to the robot 300 (S408).

The robot control apparatus 400 may determine whether the robot 300 is able to board the elevator based on elevator boarding restriction conditions.

In some embodiments, the elevator boarding restriction conditions may include the number of robots that can board the elevator. For example, an elevator may be set to allow only one robot to be boarded. In this case, the robot control apparatus 400 may determine that it is impossible for the robot 300 to board the predicted elevator if another robot has already boarded the predicted elevator or another robot is scheduled to board the predicted elevator. In some embodiments, the elevator boarding restriction conditions may include a limit load of the elevator. The robot control apparatus 400 may estimate the load of the predicted elevator and determine whether the robot 300 may is able to board the predicted elevator based on the estimated load and the weight of the robot 300. The operation status information of the elevator received from the control panel 100 and may include the loading capacity of the elevator. In this case, the robot control apparatus 400 may estimate the load of the elevator based on the loading capacity of the elevator and the weight of the robot 300.

When the robot control apparatus 400 determines that it is impossible for the robot 300 to board the predicted elevator, the robot control apparatus 400 may delay the transmission time of the elevator call signal.

In some embodiments, when the robot control apparatus 400 determines that it is impossible for the robot 300 to board the predicted elevator, the robot control apparatus 400 may transmit a call signal to the control panel 100 to call an elevator other than the predicted elevator instead of the elevator call signal.

Meanwhile, when the control panel 100 receives the elevator call signal from the robot control apparatus 400 (S410), the control panel 100 may transmit an elevator allocation request signal corresponding to the elevator call signal to the group management controller 200 (S412). The elevator call signal and the elevator allocation request signal may include information on the target floor that the robot 300 wants to board.

When the group management controller 200 receives the elevator allocation request signal, the group management controller 200 may allocate one elevator from among the plurality of elevators based on the set elevator allocation rules and the operation status information of each elevator, and transmit an elevator allocation response signal including information on the allocated elevator to the control panel 100 (S414).

Meanwhile, when the control panel 100 receives the call signal to call an elevator other than the predicted elevator from the robot control apparatus 400, the control panel 100 may allocate an elevator corresponding to the call signal.

In some embodiments, a car call signal may be used as the call signal to call an elevator other than the predicted elevator. The car call signal may be a signal used when calling an elevator. Since the car call signal is an individual elevator call, only one elevator may be affected by a car call. Therefore, in case of the car call, elevator allocation in the group management controller 200 is not required. Accordingly, the control panel 100 may control the elevator based on the car call signal.

While the allocated elevator is operating to the target floor, the control panel 100 may periodically and/or when an event occurs transmit the operation status information of the elevator to the robot control apparatus 400 (S416, S420, S426).

When the robot control device apparatus 400 receives operation status information of an elevator from the control panel 100 (S416, S420, and S426), the robot control device apparatus 400 may predict elevator allocation information of the group management controller 200 when an elevator is called based on the estimated elevator allocation rules and the operation status information of the elevator received from the control panel 100 (S406), and transmit the elevator allocation prediction information to the robot 300 (S418 and S422).

That is, the robot control apparatus 400 that receives the boarding request signal of the robot 300 may periodically predict the elevator allocation information of the group management controller 200 until the group management controller 200 actually allocates an elevator and the allocated elevator arrives at the target floor, and transmit the elevator allocation prediction information to the robot 300. At this time, the elevator allocation information may be the same or different for each prediction.

When the robot 300 receives elevator allocation prediction information from the robot control apparatus 400 (S418 and S422), the robot 300 may move to the location of the elevator to be boarded in advance based on the elevator allocation prediction information and wait (S409).

When the allocated elevator arrives at the target floor, the control panel 100 may transmit the operation status information of the elevator to the robot control apparatus 400 (S426).

The robot control apparatus 400 may check the arrival information of the allocated elevator based on the operation status information of the elevator received from the control panel 100 when the elevator arrives at the target floor.

The robot control apparatus 400 may transmit the arrival information of the elevator to the robot 300 (S428).

When the robot 300 receives arrival information of the elevator, the robot 300 may board the elevator (S430).

The robot 300 may move to the location of the elevator to be boarded in advance based on the elevator allocation prediction information of the robot control apparatus 400 and wait, so that the robot 300 may quickly board the elevator when the elevator arrives.

Meanwhile, the robot control apparatus 400 may manage the operation status history information of the elevator by storing the elevator operation status information of elevator whenever the robot control apparatus 400 receives the operation status information of elevator from the control panel 100.

In addition, the robot control apparatus 400 may manage the elevator allocation history information of the group management controller 200 by storing the elevator call time and the elevator allocation result based on the arrival information of the elevator corresponding to the elevator boarding request signal of the robot 300.

The robot control apparatus 400 may update the elevator allocation rules of the group management controller 200 based on the elevator allocation result of the group management controller 200 stored at a predetermined cycle and the operation status information of each elevator stored.

Assuming a multi-elevator and multi-robot environment in which robots A and B are located in one building, two elevators, elevator A and elevator B, are in operation in the building, and robot A and robot B provide delivery services, a method for allocating elevators to the robot A and robot B according to the elevator allocation method illustrated in FIG. 4 is described by the robot control apparatus 400. At this time, the elevator boarding restriction condition may be predetermined that only one robot could board in one elevator.

When the robot control apparatus 400 receives an elevator boarding request signal from robot A, the robot control apparatus 400 may predict the elevator allocation information of the group management controller 200 using the elevator allocation rules estimated based on the elevator allocation history information of the group management controller 200. At this time, elevator A is predicted.

The robot control apparatus 400 transmits elevator allocation prediction information including information on elevator A to robot A, and robot A may move to the location of elevator A and wait until elevator A arrives.

The elevator A was actually allocated by the group management controller 200, and robot A is boarding in elevator A.

Next, when the robot control apparatus 400 receives an elevator boarding request signal from robot B, the robot control apparatus 400 predicts the elevator allocation information of the group management controller 200 using the elevator allocation rules estimated based on the elevator allocation history information of the group management controller 200. At this time, elevator A is predicted.

However, since robot A is already on elevator A, the robot control apparatus 400 determines that it is impossible to allocate elevator A to robot B according to the elevator boarding restriction condition, and may delay the time at which the elevator call signal is transmitted to the control panel 100. As an example, the robot control apparatus 400 may transmit an elevator call signal to the control panel 100 when robot A gets off elevator A.

As another example, the robot control apparatus 400 may transmit a car call signal to the control panel 100 instead of the elevator call signal without delaying the time at which the elevator call signal is transmitted to the control panel 100. The car call signal may request allocation of a different elevator B rather than elevator A. That is, the car call signal may designate elevator B as the elevator to be allocated.

In this way, the robot control apparatus 400 determines whether a robot is able to board the predicted elevator, and when the robot cannot board the predicted elevator, the robot control apparatus 400 may optimize delivery of multi-robot by taking different ways.

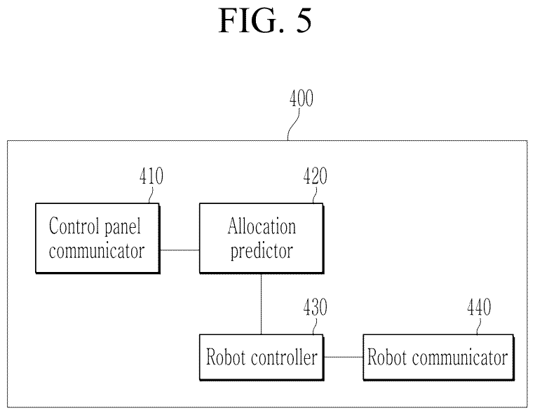

FIG. 5 illustrates a robot control apparatus according to one or more embodiments.

Referring to FIG. 5, the robot control apparatus 400 may include a control panel communicator 410, an allocation predictor 420, a robot controller 430, and a robot communicator 440.

The control panel communicator 410 provides a communication interface with the plurality of control panels 100_1, 100_2, and 100_3, and may receive operation status information of the elevators 10_1, 10_2, and 10_3 from the plurality of control panels 100_1, 100_2, and 100_3 through the communication interface, and may transmit the elevator call signal of the robot 300 to the plurality of control panels 100_1, 100_2, and 100_3.

The allocation predictor 420 may manage the operation status history information of the elevators 10_1, 10_2, and 10_3 by storing the operation status information of the elevators 10_1, 10_2, and 10_3. The allocation predictor 420 analyzes the operation status information of the elevators 10_1, 10_2, and 10_3 to check the elevator allocation result of the group management controller 200 and stores the elevator allocation result of the group management controller 200, thereby managing the elevator allocation history information of the group management controller 200.

The allocation predictor 420 may estimate the elevator allocation rules of the group management controller 200 based on the operation status information of the elevators 10_1, 10_2, and 10_3 and the elevator allocation result of the group management controller 200 collected during a predetermined period of time.

When the allocation predictor 420 receives the elevator boarding request signal from a robot through the robot controller 430, the allocation predictor 420 may predict the elevator to be allocated by the group management controller 200 based on the estimated elevator allocation rules of the group management controller 200 and the current operation status information of the elevators 10_1, 10_2, and 10_3. The allocation predictor 420 may transmit elevator allocation prediction information including information on the predicted elevator to the robot controller 430. After that, the allocation predictor 420 may transmit the elevator call signal to the control panel communicator 410.

The allocation predictor 420 may determine whether a robot is able to board the predicted elevator before transmitting the elevator call signal to the control panel communicator 410.

The allocation predictor 420 may delay the transmission of the elevator call signal when the robot cannot board the predicted elevator. When the robot cannot board the predicted elevator, the allocation predictor 420 may transmit a car call signal including information about elevator other than the predicted elevator to the control panel communicator 410.

The robot controller 430 may be responsible for the overall control of the robots. The robot controller 430 may manage the current location of the robots, performance tasks of the robots, battery and communication status of the robots, etc. The robot controller 430 may set the movement path of the robots based on the elevator allocation prediction information and control the movement of the robots. Furthermore, the robot controller 430 may perform a linkage function with external equipment such as elevators, automatic doors, and speed gates.

When the robot controller 430 receives an elevator boarding request signal through the robot communicator 440, the robot controller 430 may transmit the elevator boarding request signal to the allocation predictor 420.

When the robot controller 430 receives elevator allocation prediction information from the allocation predictor 420, the robot controller 430 may transmit the elevator allocation prediction information to the robot communicator 440.

The robot communicator 440 may provide a communication interface with the robots. The robot communicator 440 may receive an elevator boarding request signal from the robot 300 through the communication interface and transmit elevator allocation prediction information to the robot 300. In addition, the robot communicator 440 may transmit a control signal according to the movement path of the robot controller 430 to the robot 300.

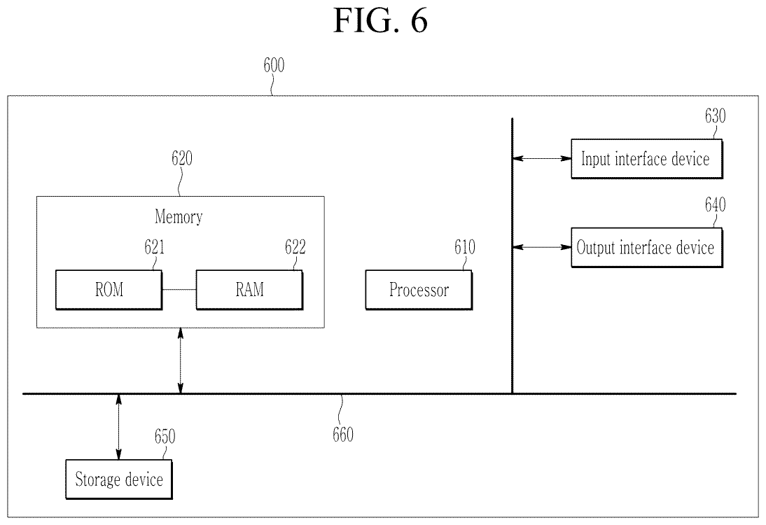

FIG. 6 illustrates a robot control apparatus according to one or more embodiments.

Referring to FIG. 6, the robot control apparatus 600 may represent a computing device in which the robot control method described above is implemented.

The robot control apparatus 600 may include at least one of processor 610, a memory 620, an input interface device 630, an output interface device 640, and a storage device 650. Each component is connected to a bus 660 and may communicate with each other. In addition, each component may be connected through an individual interface or individual bus centered on the processor 610, rather than the common bus 660.

The processor 610 may be implemented as various types such as an application processor (AP), a central processing unit (CPU), a graphics processing unit (GPU), etc., and may be any semiconductor device that executes instructions stored in the memory 620 or storage device 650. The memory 620 may store instructions configured to cause the processor 610 to perform the robot control functions, methods, and processes described above. The processor 610 may execute program instructions stored in at least one of the memory 620 and the storage device 650. The processor 610 may be configured to implement the robot control functions and methods described based on FIGS. 1 to 5.

The memory 620 and storage device 650 may include various forms of volatile or non-volatile storage media. For example, the memory 620 may include a read-only memory (ROM) 621 and a random access memory (RAM) 622. In an embodiment, the memory 620 may be located inside or outside the processor 610, and the memory 620 may be connected to the processor 610 via various means already known.

The input interface device 630 may be configured to provide data to the processor 610.

The output interface device 640 may be configured to output data from the processor 610.

Although the embodiments of the present invention have been described in detail above, the scope of the present invention is not limited thereto, and various modifications and improvements made by those skilled in the art using the basic concept of the present invention defined in the following claims also fall within the scope of the present invention.

What is claimed is:

1. A robot control method for controlling at least one robot providing a robot service in a building where a plurality of elevators installed in a robot control apparatus operated by a processor, the robot control method comprising:
receiving an elevator boarding request from a first robot among the at least one robot;
receiving operation status information of each of the plurality of elevators from each of a plurality of control panels;
predicting an elevator to be allocated by a group management controller when an elevator is called according to an elevator boarding request, based on the operation status information of each of the plurality of elevators and elevator allocation history information of the group management controller; and
transmitting allocation prediction information including information of the predicted elevator to the first robot.

2. The robot control method of claim 1, further comprising
transmitting an elevator call according to the elevator boarding request to the group management controller through at least one of the plurality of control panels, after the transmitting the allocation prediction information to the first robot.

3. The robot control method of claim 2, wherein
the receiving operation status information of each of the plurality of elevators includes periodically and non-periodically receiving operation status information of each of the plurality of elevators from each of the plurality of control panels, and
the predicting is performed each time the operation status information of each of the plurality of elevators is received until the elevator allocated by the group management controller arrives according to the elevator call.

4. The robot control method of claim 2, further comprising:
checking arrival information of the elevator allocated by the group management controller according to the elevator call, and
transmitting the arrival information to the first robot.

5. The robot control method of claim 1, further comprising
determining whether the first robot is able to board the predicted elevator, before transmitting the allocation prediction information to the first robot.

6. The robot control method of claim 5, further comprising:
transmitting the elevator call according to the elevator boarding request to the group management controller through at least one of the plurality of control panels, after transmitting the allocation prediction information to the first robot; and
delaying, until it is determined that the first robot can board the predicted elevator, a transmission of the elevator call when it is determined that the first robot cannot board the predicted elevator.

7. The robot control method of claim 5, further comprising
transmitting a call signal including information of another elevator to the group management controller through at least one of the plurality of control panels when it is determined that the first robot cannot board the predicted elevator.

8. The robot control method of claim 5, wherein
the determining whether the first robot is able to board the predicted elevator includes determining whether the first robot is able to board the predicted elevator by considering the number of robots that can board the elevator and a loading capacity of the elevator.

9. The robot control method of claim 1, wherein
the receiving operation status information of each of the plurality of elevators includes:
periodically and non-periodically receiving operation status information of each of the plurality of elevators from each of the plurality of control panels;
storing operation status information of each of the plurality of elevators;
identifying an elevator allocation result of the group management controller by analyzing the operation status information of each of the plurality of elevators; and
managing the elevator allocation history information by storing the identified elevator allocation result.

10. The robot control method of claim 9, wherein
the predicting an elevator to be allocated includes
estimating elevator allocation rules used by the group management controller for elevator allocation based on the elevator allocation history information of the group management controller stored during a predetermined period of time; and
predicting the elevator to be allocated by the group management controller using the operation status information of each of the plurality of elevators and the elevator allocation rules.

11. A robot control apparatus that controls at least one robot providing robot service in a building where a plurality of elevators are installed, the robot control apparatus comprising:
a processor and a memory,
wherein the memory stores instructions configured to cause the processor to perform a process, and the process includes:
receiving an elevator boarding request from a first robot among at least one of the robots;
receiving operation status information of the plurality of elevators from the plurality of control panels that respectively control the plurality of elevators;
predicting an elevator to be allocated by a group management controller using elevator allocation rules and operation status information of the plurality of elevators, before transmitting an elevator call according to the elevator boarding request to the group management controller; and
transmitting allocation prediction information for the elevator to be allocated by the group management controller to the first robot.

12. The robot control apparatus of claim 11, wherein
the process further includes
estimating the elevator allocation rules of the group management controller based on elevator allocation history information of the group management controller according to operation status information of the plurality of elevators received during a predetermined period of time, before receiving the elevator boarding request.

13. The robot control apparatus of claim 11, wherein
the process further includes
transmitting an elevator call according to the elevator boarding request to the plurality of control panels, after transmitting allocation prediction information to the first robot.

14. The robot control apparatus of claim 13, wherein
the predicting an elevator to be allocated by a group management controller includes
predicting an elevator to be allocated by the group management controller by using the elevator allocation rules and the operation status information of the plurality of elevators, each time the operation status information of each of the plurality of elevators is received, until the elevator allocated d by the group management controller arrives according to the elevator call.

15. The robot control apparatus of claim 11, wherein
the transmitting to the first robot includes:
determining whether the first robot is able to board the predicted elevator; and
transmitting the allocation prediction information to the first robot when the first robot can board the predicted elevator.

16. The robot control apparatus of claim 11, wherein
the process further includes
generating a call signal including information about another elevator when it is determined that the first robot cannot board the predicted elevator.

17. The robot control apparatus of claim 11, wherein
the process further includes
delaying, until it is determined that the first robot can board the predicted elevator, a transmission of the elevator call when it is determined that the first robot cannot board the predicted elevator.

18. The robot control apparatus of claim 11, wherein
the process further includes
updating the elevator allocation rules at a predetermined cycle while the plurality of elevators are in operation.
